(19) United States
(12) Patent Application Publication
(10) Pub. No.: US 2004/0079781 A1
(43) Pub. Date: Apr. 29, 2004

(54) Combination of tube and cap assembly for stapling gun

(76) Inventor: Chen-Fa Huang, Ta Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/689,681

(22) Filed: Oct. 22, 2003

Related U.S. Application Data
(63) Continuation-in-part of application No. 10/060,771, filed on Feb. 1, 2002, now abandoned.

(51) Int. Cl. B25C 7/00

(52) U.S. Cl. 227/15; 227/18

(57) ABSTRACT

A stack of caps each have a central hole and a connection cord frictionally extends through the central holes for collection the caps as a stack. A ring is connected to a first end of the cord and an enlarged end piece is integrally formed on a second end of the cord. The enlarged end piece is slightly larger than the central hole of each cap so that it is allowed to be pulled through the central holes when the cord is pulled out from the stack of the caps. A pushing mechanism includes a cover and a pushing rod which movably extends through the cover. The cover is threadedly engaged with the threaded inner periphery defined in the open top of the tube and a spring is mounted to the pushing rod. A pushing end is connected to the pushing rod so as to press on a top of the stack of the caps.

### FIELD OF THE INVENTION

This application is a Continuation-In-Part application of applicant's former application with application Ser. No. 10/060,771, filed on Feb. 1, 2002, entitled as “CAP CONNECTION CORD FOR STAPLING GUN”.

### BACKGROUND OF THE INVENTION

A conventional cap feeding device attached to a stapling gun 12 is shown in FIG. 1 and includes a positioning mechanism 13 connected to a side of the stapling gun 12 and a spring 15 with a pushing rod 16 extends through the positioning mechanism 13. A plate 14 is connected to the nose of the stapling gun 12 and has a groove to receive the caps 10 therein. The caps 10 are stacked up in a tube 11 which is engaged between the plate 14 and the positioning mechanism 13. The pushing rod 16 has a pushing end 161 which pushes the top one of the stack of the caps 10 toward the plate 14 so that the caps 10 are fed in the groove one by one. A pneumatic system (not shown) is used to push the caps 10 in the groove to be fed so that a staple or nail may extend through a central hole of the cap 10 fed below the nose of the stapling gun 12. However, the tube 11 and the stack of the caps 10 are assembled to be a assembly by the manufacturers when the user purchases assembly so that the user cannot open the tube to adjust any cap in the tube 11. Therefore, once one of the caps 10 is stocked in the tube 11, the whole assembly is to be discarded. This is not benefit to the users and has to be improved.

U.S. Pat. No. 5,167,327 discloses a lading system for fasten collars wherein the collars are trained to the flexible mandrel which is slightly less than the length of magazine in order to allow the presence of a small number of unused collars which may be remaining within the magazine from prior applications. A tapered nose piece is removably fitted onto the tube to guide each collar onto the tube. The nose piece may be initially inserted in fitting with a loose fit which allows the tapered end of the nose piece to self center itself in fitting once the collars are drawn into the tube via suction. The nose piece is then removed from tube and exposed end portion of the tube pulled to remove the mandrel-collar package from suction tube. Obviously, the disclosure involves too many parts and a complicated structure.

### SUMMARY OF THE INVENTION

In accordance with one aspect of the present invention, there is provided a combination of tube and cap assembly for a stapling gun. There is a central hole in each of the caps and a connection cord has a ring connected to a first end thereof and the cord frictionally fits in the hole in each of the caps. An enlarge end piece is integrally formed to a second end of the cord and slightly larger than the central hole of each cap such that the enlarged end piece can be moved through the central holes when pulling the cord from the stack of the caps. The tube has two open ends and one of which includes a threaded inner periphery so as to be connected with a cover of a pushing mechanism.

The primary object of the present invention is to provide a connection cord that frictionally extends through the central holes of a stack of caps and the cord is conveniently pulled out from the central holes when the caps are put in the tube of the feeding device of the stapling gun.

Another primary object of the present invention is to provide a connection cord that has an enlarged end piece which is slightly larger than the central hole of each cap so as to keep the stack of the caps trained on the cord before being put in the tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a stapling gun and a conventional tube in which the caps are received;

FIG. 2 is a cross sectional view to show that the conventional tube with the caps therein is engaged with the pushing rod;

FIG. 3 is a cross sectional to show the stack of caps are connected by the connection cord of the present invention;

FIG. 4 is a perspective view to show the stack of caps are connected by the connection cord of the present invention, and

FIG. 5 is a cross sectional view to show that the stack of caps are put in the tube and pushed by the pushing rod.

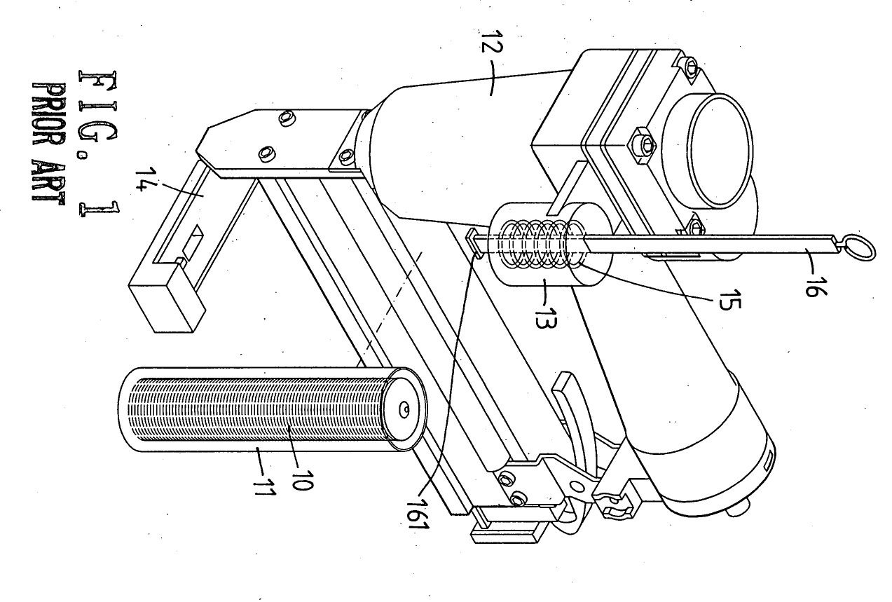

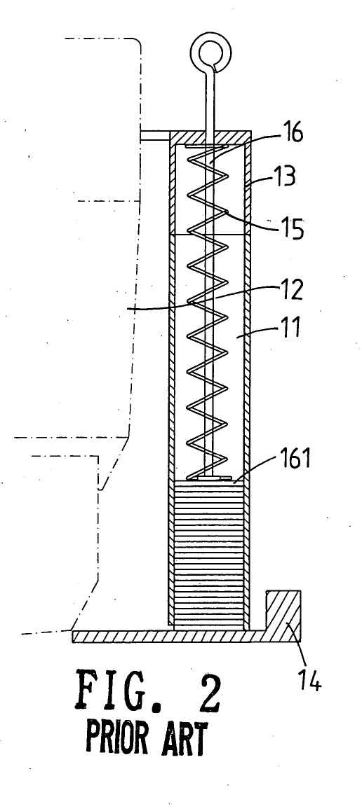

### DETAILED DESCRIPTION OF THE PREFERRED EMBODIMENT

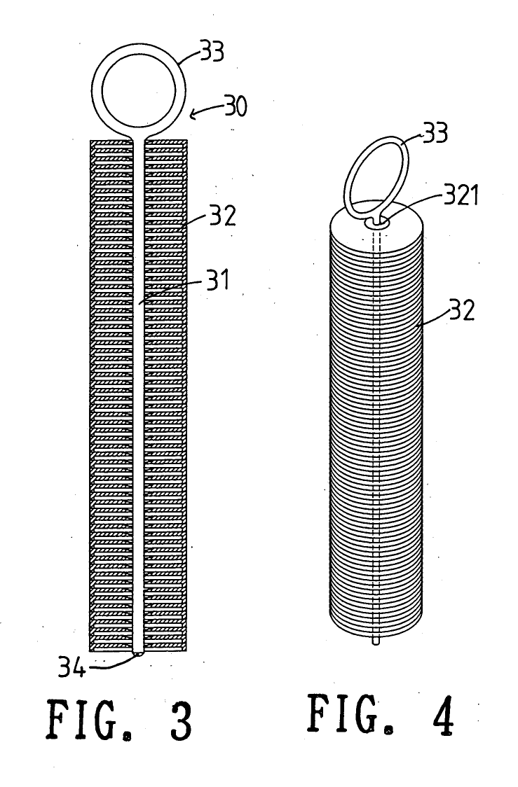

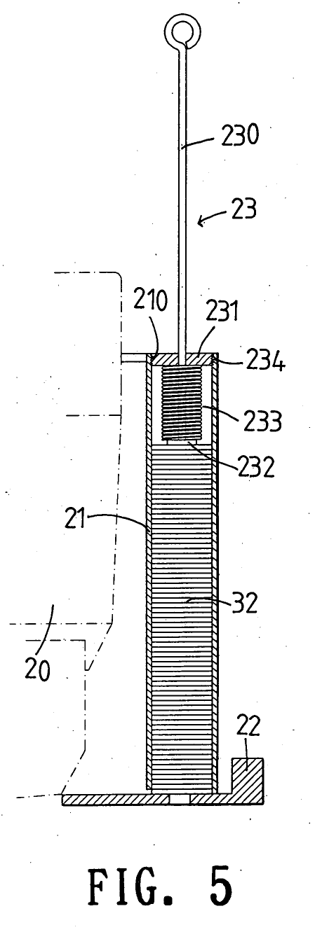

Referring to FIGS. 3 to 5, the connection cord 30 for connecting caps 32 of the present invention comprises a ring 33 connected to a first end of the cord 30 and the cord 30 frictionally extends through the central hole 321 in each of the caps 32. The ring 33 is much larger than the central holes 321 of the caps 32. An enlarged end piece 34 is integrally formed on a second end of the connection cord 30, wherein the enlarged end piece 34 is slightly larger than the inner diameter of the central hole 321 of each cap 32 so that when the caps 32 are trained onto the connection cord 30, they do not drop or remove from the connection cord 30 because of the ring 33 and the enlarged end piece 34. The friction between the central holes 321 of the caps 32 and the connection cord 30 performs an important role for maintaining the caps 32 on the cord 30.

The stack of the caps 32 collected by the cord 30 can be hanged by holding the ring 33 and easily brought to be put in the tube 21 attached to the stapling gun 20. The cord 30 is then pulled out from the stack of the caps 32 by lifting the ring 33 till the cord 30 is completely removed from the stack of the caps 32. It is to be noted that the enlarged end piece 34 is made by a material that is allowed to be deformed slightly so as to move through the central holes 321 of the caps 32 when pulling the connection cord 30.

The tube 21 has an open top and an open bottom, a threaded inner periphery 210 is defined in the open top of the tube 21 the open bottom is rested on a plate 22 connected to the nose of the stapling gun 20. A pushing mechanism 23 including a pushing rod 230 which movably extends through a cover 231 is engaged with the open top of the tube 21. The cover 231 has a threaded outer periphery 234 which is threadedly connected to the threaded inner periphery of the tube 21 and the pushing rod 230 is cooperated with a spring 233 and includes a pushing end 232 which pushes the top of the stack of the caps 32 toward the plate 22 connected to the nose of the stapling gun 20. A gap is defined between the top surface of the plate 22 and the open bottom of the tube 21. The cap 32 that is located at the lower end of the stack of the caps 32 is then pushed out from the open bottom of the tube 21 and is pushed by a feeding mechanism (not shown) to the nose of the stapling gun 20 and to be stapled with a nail.

The caps 32 are collected as a stack by simply a cord 30 which occupies much less space in comparison with the conventional tube. The connection cord 30 can be re-used again without any part of which is discarded.

While we have shown and described the embodiment in accordance with the present invention, it should be clear to those skilled in the art that further embodiments may be made without departing from the scope of the present invention.

What is claimed is:

1. A cap feeding assembly for stapling gun, comprising:
a tube adapted to be connected a the stapling gun and having an open top and an open bottom, the open bottom being rested on a plate adapted to be connected to the stapling gun, a gap defined between a top surface of the plate and the open bottom of the tube, the open top having a threaded inner periphery;
a stack of caps each having a central hole defined therethrough, a connection cord having a ring connected to a first end of the cord and the cord frictionally fit in the central hole in each of the caps, the ring being larger than the central holes of the caps, an end piece integrally formed on a second end of the connection cord and being slightly larger than the inner diameter of the central hole of each cap such that the enlarged end piece moves through the central holes of the stack of the caps when pulling the connection cord from the stack of the caps, and
a pushing mechanism including a pushing rod which movably extends through a cover, the cover having a threaded outer periphery which is threadedly connected to the threaded inner periphery of the open top of the tube, a spring mounted to the pushing rod and includes a pushing end which pushes a top of the stack of the caps toward the plate.
